(19) United States
(12) Patent Application Publication
(10) Pub. No.: US 2026/0330164 A1
(43) Pub. Date: Oct. 22, 2026

(54) ASSET MANAGEMENT METHOD

(71) Applicant: RiConnect, Inc., Taichung City (TW)

(72) Inventors: RONG-DER HONG, Taichung City (TW); HSIN-LUNG WANG, Taichung City (TW)

(73) Assignee: RiConnect, Inc., Taichung City (TW)

(21) Appl. No.: 19/182,524

(22) Filed: Apr. 17, 2025

(51) Int. Cl. G06K 7/10; H04W 4/021

(52) U.S. Cl. CPC G06K 7/10366; H04W 4/021

(57) ABSTRACT

An asset management method includes the follow steps: obtaining, by an electronic device, a unique identification code of an RFID tag provided on a target asset and a geolocation information; transmitting, by the electronic device, the unique identification code, the geolocation information and an inspection data to a data management system; based on the unique identification code, searching, by the data management system, for one corresponding target asset data in the database; determining, by the data management system, whether the geolocation information is located within a geographical area range of the target asset data: if so, the data management system records the geolocation information and the inspection data in the target asset data; if not, the data management system transmits an alert message to the electronic device.

### BACKGROUND OF THE INVENTION

### Technical Field

The present invention relates generally to asset management, and more particularly to an asset management method that uses geolocation information to manage assets.

### Description of Related Art

Mostly, for the purpose of managing various assets, producers or owners of assets record basic information of the assets. For companies with many assets, the basic information of the assets will be further filed for easy management and maintenance

Taking the management of lifting equipment (such as hook, buckle, carabiner, fall arrester, etc.) as an example, since the lifting equipment involves the safety of life and property, inspections of the lifting equipment are required to ensure safety and reliability.

However, due to the fact that such assets are not fixed in one location for placement or use, inspectors frequently encounter difficulties determining whether the assets are located where the assets are intended to be placed or used, leading to considerable inconvenience during asset inspection.

### BRIEF SUMMARY OF THE INVENTION

In view of the above, the primary objective of the present invention is to provide an asset management method that could notify the inspectors when a target asset to be inspected is outside an expected geographical area range.

The present invention provides an asset management method applied to a data management system. The data management system includes a database that stores a plurality of asset data corresponding to a plurality of assets, each of the plurality of asset data including an identification code corresponding to one of the assets. The asset management method comprises steps of:
A. providing an electronic device, wherein the electronic device has a radio-frequency identification (RFID) reading module; the electronic device reads an RFID tag on a target asset through the RFID reading module to obtain a unique identification code of the RFID tag; the electronic device receives a geolocation information from a positioning system;
B. connecting the electronic device to the data management system, and transmitting, by the electronic device, the unique identification code, the geolocation information and an inspection data to the data management system;
C. based on the unique identification code received, searching, by the data management system, for one corresponding asset data in the database to form a target asset data, wherein the identification code of the target asset data matches the unique identification code; and
D. determining, by the data management system, whether the geolocation information is located within a geographical area range of the target asset data, wherein:
when the geolocation information is located within the geographical area range of the target asset data, the data management system records the geolocation information and the inspection data in the target asset data;
when the geolocation information is located outside the geographical area range of the target asset data, the data management system transmits an alert message to the electronic device.

With the aforementioned design, when the target asset to be inspected is within the expected geographical area range, the inspection data thereof could be recorded in the target asset data; when the target asset to be inspected is outside the expected geographical area range, the alert message is generated to notify the inspector.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic diagram of a data management system and a connection structure thereof, to which an asset management method of an embodiment according to the present invention is applied;

FIG. 2 is a schematic diagram of a content of a database of the embodiment according to the present invention;

FIG. 3 is a flow chart of a setting step of the asset management method of the embodiment according to the present invention;

FIG. 4 is a schematic diagram of a map range selection page of the embodiment according to the present invention;

FIG. 5 is a flow chart of an inspection step of the asset management method of the embodiment according to the present invention;

FIG. 6 is a flow chart of a change step of the asset management method of the embodiment according to the present invention;

FIG. 7 is a schematic diagram of a map range selection page of the embodiment according to the present invention;

FIG. 8 is a schematic diagram of an electronic map displayed on a screen of an electronic device of the embodiment according to the present invention;

FIG. 9 is a schematic diagram of an electronic map displayed on the screen of the electronic device of the embodiment according to the present invention;

FIG. 10 is a schematic diagram of an electronic map displayed on the screen of the electronic device of the embodiment according to the present invention; and

FIG. 11 is a schematic diagram of an electronic map displayed on a screen of an electronic device of the embodiment according to the present invention.

### DETAILED DESCRIPTION OF THE INVENTION

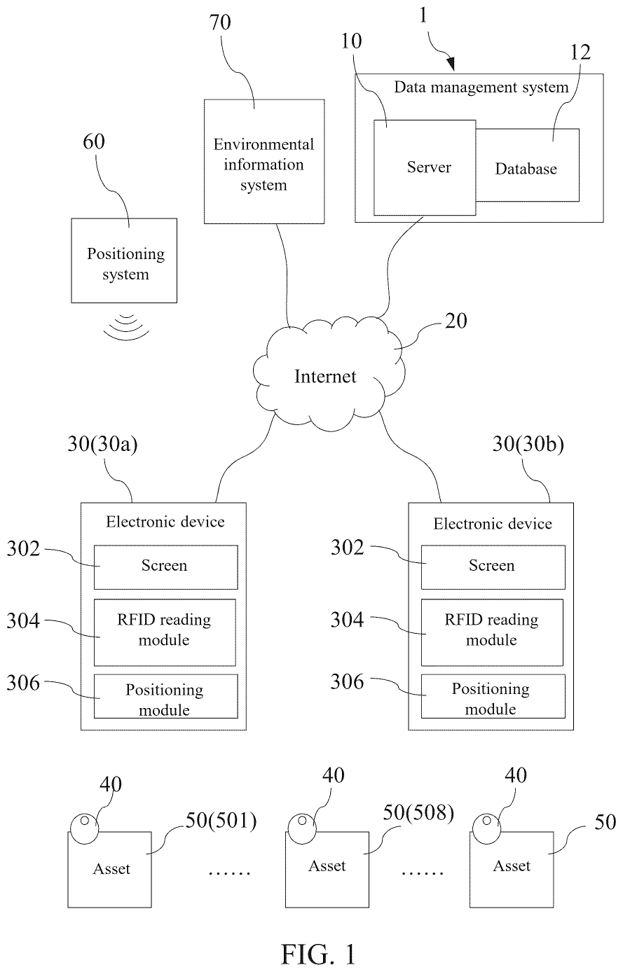

As shown in FIG. 1, a data management system 1 and a connection structure thereof, to which an asset management method of an embodiment according to the present invention is applied, are illustrated. The data management system 1 includes a server 10 and a database 12, wherein the server 10 is connected to the Internet 20 in a wired or wireless manner. In the current embodiment, the database 12 is independent of the server 10, but it is not limited thereto; the database 12 and the server 10 could be integrated into the same host.

At least one user uses at least one electronic device 30 that connects to the server 10 of the data management system 1 via the Internet 20. The electronic device 30 could be a wired or wireless device connected to the Internet 20, such as a smartphone, a tablet computer, or a laptop computer. In FIG. 1, a plurality of the electronic devices 30 are illustrated, and users of the plurality of electronic devices 30 are a plurality of inspectors.

Each of the electronic devices 30 has a screen 302, a radio-frequency identification (RFID) reading module 304 and a positioning module 306. The screen 302 is configured to display data, and the RFID reading module 304 is configured to read an RFID tag 40 in a contactless manner to obtain a unique identification code (UID) of the RFID tag 40. The RFID tag 40 is provided on an asset 50. In the current embodiment, a plurality of RFID tags 40 are respectively provided on a plurality of assets 50, each asset 50 being provided with one of the RFID tags 40 and each of the RFID tags 40 recording a corresponding unique identification code. The plurality of assets in the current embodiment is exemplified by lifting equipment, such as hook, buckle, carabiner, fall arrester, etc. The RFID reading module 304 could be built in a body of the electronic device 30, but it is not limited thereto. The RFID reading module 304 could be independent of the body of the electronic device 30 and be connected to the body of the electronic device 30 in a wired or wireless manner. The positioning module 306 is configured to receive geolocation information from a positioning system 60. In the current embodiment, the positioning system 60 is exemplified by the global positioning system (GPS), and the geolocation information received includes latitude and longitude. In an embodiment, the positioning system could also be telecommunication networks, Wi-Fi networks, Bluetooth, or radio frequency positioning systems.

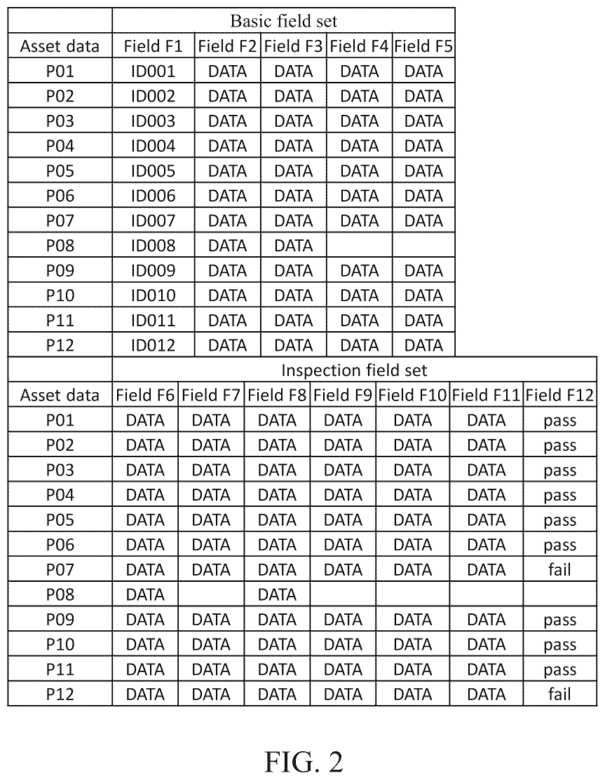

The server 10 is configured to process data stored in the database 12. As shown in FIG. 2, a plurality of asset data P01 to P12 are stored in the database 12, and the plurality of asset data P01 to P12 respectively correspond to the plurality of assets 50. A producer or an owner of the assets 50 employs a management device connected to the server 10, such as a computer, to transmit the plurality of asset data P01 to P12 to the server 10, whereby the plurality of asset data P01 to P12 is established in the database 12 through the server 10.

Each of the plurality of asset data P01 to P12 includes a plurality of fields (field F1 to field F12) that include a basic field set (field F1 to field F5) and an inspection field set (field F6 to field F12). Basic information of each of the plurality of asset data P01 to P12 is recorded in the fields of the basic field set (field F1 to field F5). For example, field F1 is an identification code field in which an identification code corresponding to the unique identification code of the RFID tag 40 on the asset 50 is recorded; field F2 is for recording an asset name; field F3 is for recording an asset number; field F4 is for recording geolocation information of a location where the asset 50 is intended to be placed or used, and the geolocation information could be, for example, latitude and longitude; field F5 is for recording a geographical area range corresponding to the geolocation information, that is, in real-world scenarios, the location where the asset 50 is intended to be placed or used is located within an area corresponding to the geographical area range. The identification code recorded in each field F1 is represented as “ID001” to “ID012”, and the content recorded in each field F2 to each field F5 is represented as “DATA”. With the identification code recorded in each field F1, the unique identification code of each RFID tag 40 is able to correspond to one of the plurality of asset data P01 to P12 and one of the assets 50.

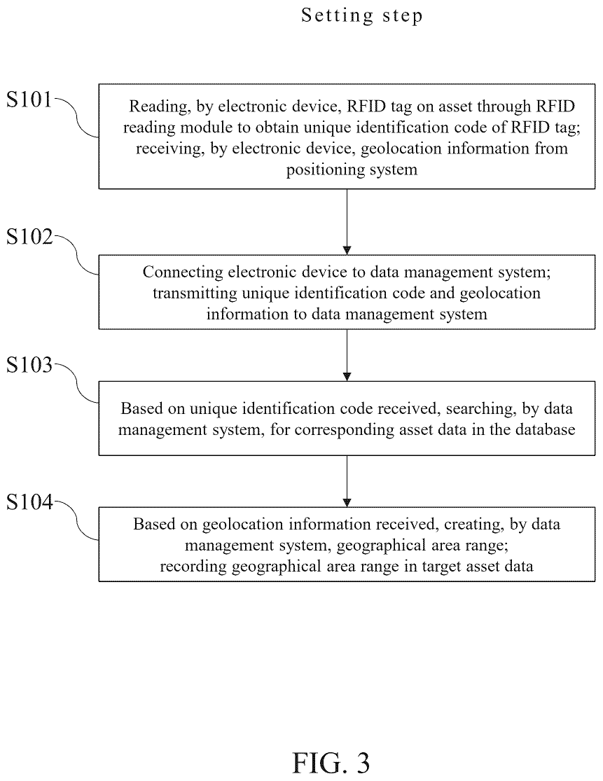

Taking the asset data P08 that corresponds to the asset 508 as an example, when the location where the asset 508 is placed or used has not yet been determined, field F4 and field F5 of the asset data P08 corresponding to the asset 508 are empty, that is, there are no records of the geolocation information and the geographical area range. The asset 508 could be defined as a target asset, and the corresponding asset data P08 could be defined as a target asset data. The inspector is designated to set the geolocation information and the geographical area range of the asset data P08 of the asset 508. In the current embodiment, the geolocation information and the geographical area range are set through a setting step of the asset management method. As shown in FIG. 3, the setting step includes the following.
Step S101: after the inspector arrives at the location where the asset 508 (target asset) is located, the inspector uses the electronic device 30, exemplified by the electronic device 30a, to read the RFID tag 40 on the asset 508 (target asset) through the RFID reading module 304 to obtain the unique identification code, such as ID008, of the RFID tag 40. The electronic device 30a receives a geolocation information from the positioning system 60.
Step S102: the electronic device 30a is connected to the data management system 1 and transmits the unique identification code and the geolocation information that are obtained in step S101 to the data management system 1. In the current embodiment, after the inspector operates the electronic device 30a to connect to the server 10, the electronic device 30a transmits the unique identification code and the geolocation information to the server 10.
Step S103: based on the unique identification code received, the data management system 1 searches for the corresponding asset data P08 (target asset data) in the database 12. In the current embodiment, after receiving the unique identification code, the server 10 compares the unique identification code with the contents in the identification fields (field F1) of each of the plurality of asset data P01 to P12 to find one matching identification code. When the matching identification code is found, the corresponding asset data P08 is identified as the target asset data.
Step S104: based on the geolocation information received, the data management system 1 creates the geographical area range and records the geographical area range in the target asset data.

In the current embodiment, the server 10 records the geolocation information in field F4 of the asset data P08 (target asset data), in which the geolocation information recorded serves as the geolocation information of the location where the asset 508 (target asset) is intended to be placed or used. And, based on the geolocation information, the server 10 creates the geographical area range and records the geographical area range in field F5 of the asset data P08. More specifically, in the setting step, the step that the data management system 1 creates the geographical area range includes the following.

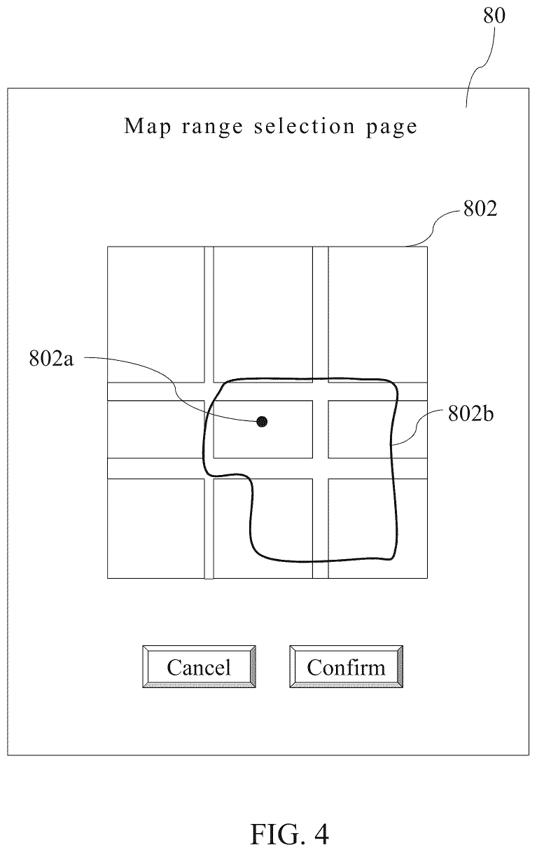

Based on the geolocation information received, the server 10 of the data management system 1 generates a map range selection page 80 (shown in FIG. 4), wherein the map range selection page 80 has an electronic map 802 corresponding to the geolocation information, and a current location 802a corresponding to the geolocation information is shown on the electronic map 802. The server 10 of the data management system 1 transmits the map range selection page 80 to the electronic device 30a and displays the map range selection page 80 on the screen 302. The inspector using the electronic device 30a selects a predetermined range 802b on the electronic map 802 of the map range selection page 80 displayed on the screen 302. The predetermined range 802b could be, for example, a geographical area range for placing or using the asset 508 (target asset), such as a facility area where the asset 508 is located, and the predetermined range 802b covers the current location 802a. The electronic device 30a transmits the predetermined range 802b to the server 10 of the data management system 1. Based on the predetermined range 802b, the server 10 of the data management system 1 creates the geographical area range that covers the geolocation information.

In addition to creating the geographical area range in the manner described above, in an embodiment, the data management system 1 could create a region with a predetermined radius centered on the geolocation information, serving as the geographical area range. The predetermined radius could be set by the inspector through the electronic device 30a.

The geolocation information and the geographical area range of the location where each asset 50 is intended to be placed or used could be set through the aforementioned setting step and be recorded in field F4 and field F5 of each of the plurality of asset data P01 to P12.

The fields of the inspection field set (field F6 to field F12) of each of the plurality of asset data P01 to P12 records an inspection data of each of the plurality of asset data P01 to P12. For example, in each of the plurality of asset data P01 to P12, a predetermined inspection cycle of the asset 50 is recorded in field F6, and the predetermined inspection cycles for different asset data P01 to P12 could be the same or different. Each predetermined inspection cycle could be, for example, one year, and has a start date and an end date. Prior to use, the asset 50 is required to be inspected and certified as passing within the corresponding predetermined inspection cycle. A user name or employee number of the inspector is recorded in field F7; an inspection standard is recorded in field F8; an inspection date is recorded in field F9; a geolocation information during inspection is recorded in field F10; an inspected part is recorded in field F11; an inspection status data is recorded in field F12. The contents recorded in fields F6 to fields F11 are represented as “DATA”. The content recorded in field F12 is one of a pass status and a fail status. If it is a pass status, the content is represented as “pass”; if it is a fail status, the content is represented as “fail”. Each abovementioned inspection data could be uploaded to the database 12 for storage by the inspector using the electronic device 30a to connect to the server 10. In the current embodiment, a part of fields of the inspection field set, for example, the inspection standard recorded in field F8, could be set to read-only to prevent modification by the inspector. Taking the asset data P08 as an example, when the asset has not yet been inspected, field F7, field F9, field F11, and field F12 are empty.

The aforementioned field set, the number of fields, and the contents in fields are only examples rather than limitations on the asset management method of the present invention. Additionally, when the content in each field of each of the plurality of asset data P01 to P12 is added, changed, or deleted, the server 10 of the data management system 1 records the added, changed, or deleted content of each field in a log record of the database 12 for subsequent tracking purpose.

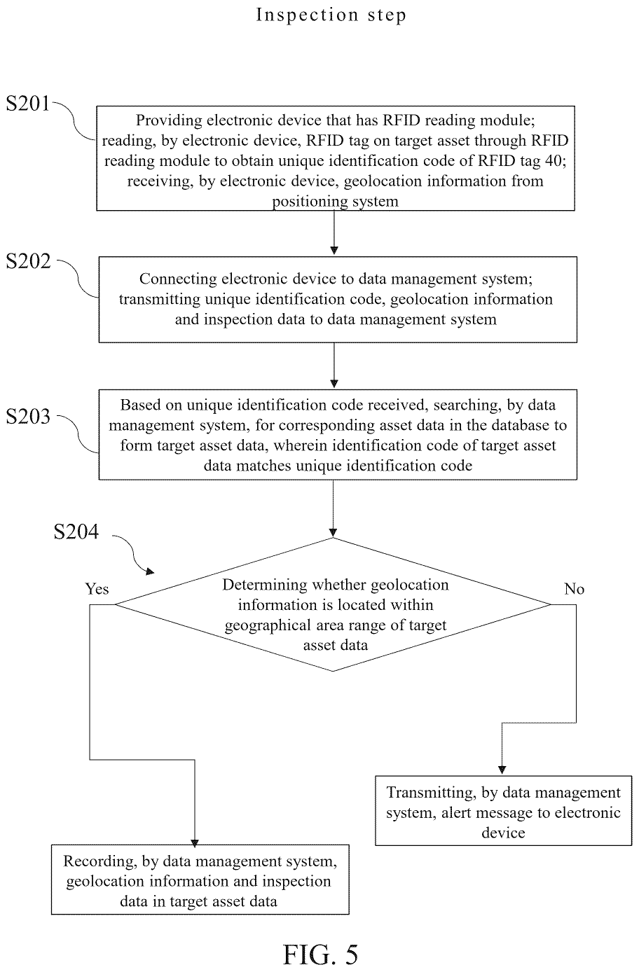

An inspection step of the asset management method of the current embodiment is hereinafter described. The inspection step is provided for inspecting at least one of the target assets and includes the steps as shown in FIG. 5. The following focuses on the asset 508, which is considered the target asset, as an illustrative example.
Step S201: after the inspector arrives at the location where the asset 508 (target asset) is located, the inspector uses the electronic device 30a to read the RFID tag 40 on the asset 508 through the RFID reading module 304 to obtain the unique identification code, such as ID008, of the RFID tag 40. The electronic device 30a receives a geolocation information from the positioning system 60.
Step S202: the electronic device 30a is connected to the data management system 1 and transmits the unique identification code, the geolocation information and an inspection data to the data management system 1. In the current embodiment, after the inspector operates the electronic device 30a to connect to the server 10, the inspector inputs the inspection data to the electronic device 30a. The inspection data includes the user name or employee number of the inspector, the inspection date, the inspected part, and the pass status or the fail status. The electronic device 30a transmits the unique identification code, the geolocation information and the inspection data to the server 10. In the current embodiment, when the electronic device 30a is unable to connect to the data management system 1, the electronic device 30a temporarily stores the unique identification code, the geolocation information and the inspection data in a storage medium of the electronic device 30a. After the electronic device 30a is able to connect to the data management system 1, the electronic device 30a then transmits the unique identification code, the geolocation information and the inspection data to the data management system 1.
Step S203: based on the unique identification code received, the data management system 1 searches for the corresponding asset data P08 (target asset data) in the database 12 to form the target asset data, wherein the identification code of the target asset data matches the unique identification code. In the current embodiment, after receiving the unique identification code, the server 10 compares the unique identification code with the contents in the identification fields (field F1) of each of the plurality of asset data P01 to P12 to find one matching identification code. When the matching identification code is found, the corresponding asset data P08 is identified as the target asset data.
Step S204: the data management system 1 determines whether the geolocation information received is located within the geographical area range of the target asset data. In the current embodiment, the server 10 compares the geolocation information received with the geographical area range recorded in field F5 of the asset data P08.

When the server 10 determines that the geolocation information is located within the geographical area range of the asset data P08 (target asset data), representing that the target asset is located within the geographical area range corresponding to the location where the target asset is intended to be placed or used, then the server 10 of the data management system 1 records the geolocation information and the inspection data in the asset data P08 (target asset data). For example, the inspection data is recorded in field F7, field F9, field F11, and field F12 of the asset data P08, and the geolocation information is recorded in field F10.

When the server 10 determines that the geolocation information is located outside the geographical area range of the asset data P08 (target asset data), representing that the target asset is moved outside the geographical area range corresponding to the location where the target asset is intended to be placed or used, then the server 10 of the data management system 1 transmits an alert message to the electronic device 30a. After receiving the alert message, the electronic device 30a displays the alert message on the screen 302 to inform the inspector that the current location where the target asset is located does not match the location where the target asset is intended to be placed or used. The server 10 of the data management system 1 temporarily does not record the inspection data in the asset data P08 (target asset data).

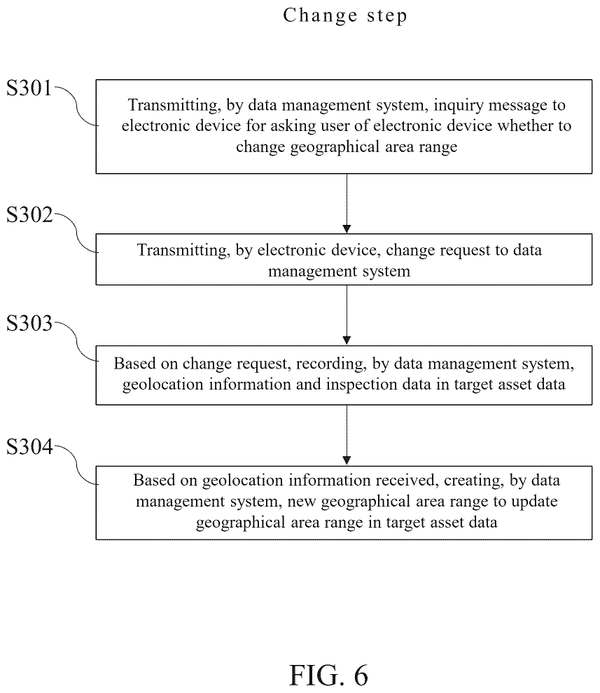

In the current embodiment, when the geolocation information is outside the geographical area range of the target asset data, a change step for changing the geographical area range where the target asset is intended to be placed or used is further included. The change step includes the following as shown in FIG. 6.
Step S301: the data management system 1 transmits an inquiry message to the electronic device 30a, wherein the inquiry message is for asking the user (inspector) of the electronic device 30a whether to change the geographical area range. In the current embodiment, the server 10 generates the inquiry message, transmits the inquiry message to the electronic device 30a, and displays the inquiry message on the screen 302.
Step S302: the electronic device 30a transmits a change request to the data management system 1. In the current embodiment, when the inspector confirms to change the geographical area range, the inspector operates the electronic device 30a to transmit the change request to the server 10.
Step S303: based on the change request, the data management system 1 records the geolocation information and the inspection data in the target asset data.

The server 10 of the data management system 1 records the geolocation information in field F4 and field F10 of the asset data P08 (target asset data), and records the inspection data in field F7, field F9, field F11, and field F12 of the asset data P08.
Step S304: based on the geolocation information received, the data management system 1 creates a new geographical area range to update the geographical area range in the target asset data. In the current embodiment, the server 10, based on the geolocation information received, creates a new geographical area range and records the new geographical area range in field F5 of the asset data P08, replacing the original geographical area range. More specifically, in the change step, the step that the data management system 1 creates the new geographical area range includes the following.

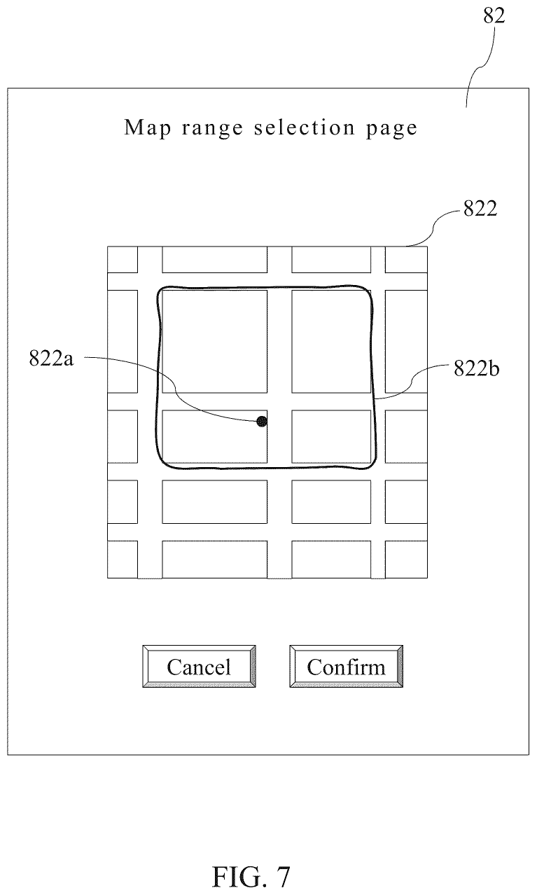

Based on the geolocation information received, the server 10 of the data management system 1 generates a map range selection page 82 (shown in FIG. 7), wherein the map range selection page 82 has an electronic map 822 corresponding to the geolocation information received, and a current location 822a corresponding to the geolocation information is shown on the electronic map 822. The server 10 of the data management system 1 transmits the map range selection page 82 to the electronic device 30a and displays the map range selection page 82 on the screen 302. The inspector using the electronic device 30a selects a predetermined range 822b on the electronic map 822 of the map range selection page 82 displayed on the screen 302. The predetermined range 822b could be, for example, a new geographical area range for placing or using the asset 508 (target asset), such as a new facility area where the asset 508 is located, and the predetermined range 822b covers the current location 822a. The electronic device 30a transmits the predetermined range 822b to the server 10 of the data management system 1. Based on the predetermined range 822b, the server 10 of the data management system 1 creates the new geographical area range that covers the geolocation information.

In addition to creating the new geographical area range in the manner described above, in an embodiment, the data management system 1 could create a region with a predetermined radius centered on the geolocation information received, serving as the new geographical area range. The predetermined radius could be set by the inspector through the electronic device 30a.

The geolocation information and the geographical area range of the location where each asset 50 is intended to be placed or used could be set through the aforementioned change step and be recorded in field F4 and field F5 of each of the plurality of asset data P01 to P12.

In the current embodiment, multiple of the plurality of asset data P01 to P12 in the database 12 respectively have another geolocation information, that is, the geolocation information recorded in field F4 of each of the plurality of asset data P01 to P07, P09 to P12, excluding the target asset data P08, is defined as another geolocation information.

Subsequent to step S304, the inspection step further includes the following.

The data management system 1 selects at least one of the plurality of asset data corresponding to at least one of the plurality of another geolocation information located within the geographical area range to form at least one another target asset data. For example, the another geolocation information of the asset data P01 is located within the geographical area range of the asset data P08. The server 10 selects the asset data P01 out of the asset data P01 to P07, P09 to P12, and the asset data P01 selected forms the another target asset data.

The data management system 1 generates a list to be inspected including at least one item that includes the another geolocation information of the at least one another target asset data. In the current embodiment, the server 10 of the data management system 1 generates the list to be inspected including an item. The item at least includes the another geolocation information (i.e., field F4) of the asset data P01 (another target asset data). The item may also include other fields of the basic field set of the asset data P01, such as the identification code in field F1, the asset name in field F2, or the asset number in field F3.

The data management system 1 transmits the list to be inspected to the electronic device 30a. In the current embodiment, the server 10 transmits the list to be inspected to the electronic device 30a.

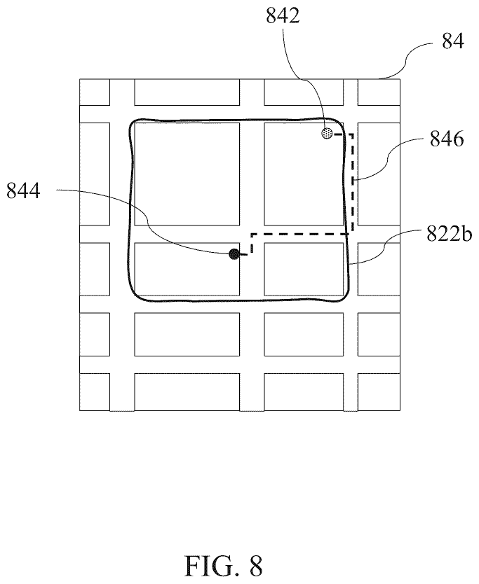

As shown in FIG. 8, based on the another geolocation information of the asset data P01 (the another target asset data), the electronic device 30a displays a target location 842 on an electronic map 84 on a screen 302 of the electronic device 30a, and generates a route 846 on the electronic map 84 from a current location 844 to the target location 842, wherein the current location 844 corresponds to the geolocation information.

In this way, the inspector could identify the location of another asset 50 (another target asset) to be inspected through the electronic device 30a, and the inspector could follow the route 846 to the location where the another target asset is located for inspection. The step for inspecting the another target asset is the same as step S301 to S304.

The above is illustrated by an example of one of the plurality of another target asset data. In the case where there is more than one of the plurality of another target asset data, for example, when the another geolocation information of the plurality of asset data P01 to P05 are located within the geographical area range of the asset data P08 (target asset), the server 10 of the data management system 1 selects the plurality of asset data P01 to P05 out of the plurality of asset data P01 to P07, P08 to P12, and the plurality of selected asset data P01 to P05 form a plurality of the another target asset data.

The list to be inspected generated by the server 10 of the data management system 1 includes the plurality of items, each item at least including the another geolocation information of each of the plurality of another target asset data.

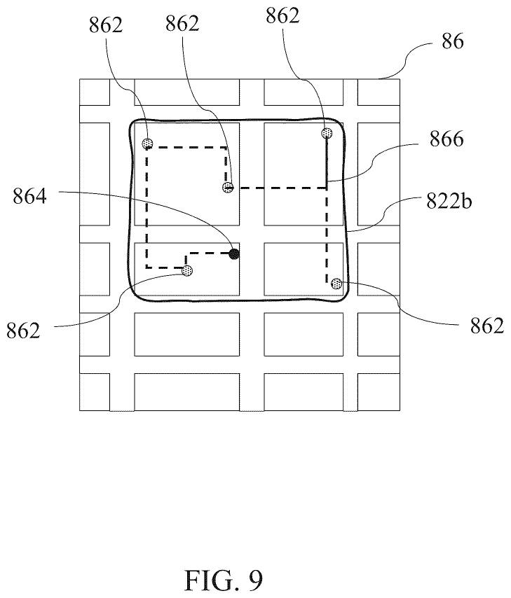

As shown in FIG. 9, based on the plurality of another geolocation information of the plurality of asset data P001 to P05 (the plurality of another target asset data), the electronic device 30a displays the plurality of target locations 862 on the electronic map 86 on the screen 302 of the electronic device 30a, and the route 866 displayed connects the current location 864 and the plurality of target locations 862. In this way, the inspector could identify the locations of other assets 50 to be inspected (the plurality of another target assets) through the electronic device 30a, and the inspector could follow the route 866 to the locations where the plurality of another target assets are located for inspection. The step for inspecting each another target asset is the same as step S301 to S304.

The inspector could also transfer a part of the items in the list to be inspected to another inspector for inspection.

The inspector could use the electronic device 30a to select a part of the items in the list to be inspected as a plurality of transfer items and transmit the plurality of transfer items to the server 10 of the data management system 1.

Based on the transfer items received, the server 10 of the data management system 1 generates another list to be inspected.

The another inspector operates another electronic device 30b to connect to the data management system 1. The electronic device 30b transmits the geolocation information received to the server 10. When the server 10 determines that the geolocation information of the electronic device 30b is located within the geographical area range of the asset data P08 (target asset data), the server 10 of the data management system 1 transmits the another list to be inspected to the electronic device 30b. The data management system 1 transmits a delete command to the electronic device 30a, the delete command serving to specify the deletion of the transfer items. After receiving the delete command, the electronic device 30a deletes the transfer items in the list to be inspected.

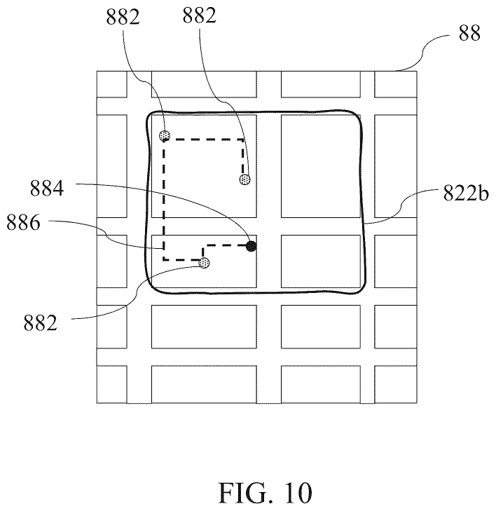

As shown in FIG. 10, after receiving the delete command and then deleting the transfer items in the list to be inspected, the electronic device 30a displays the corresponding target locations 884 on the electronic map 88 on the screen 302 of the electronic device 30a based on the plurality of another geolocation information of the items remaining in the list to be inspected, and the electronic device 30a generates a new route 886. The new route 886 connects the current location 884 and the corresponding target locations 882.

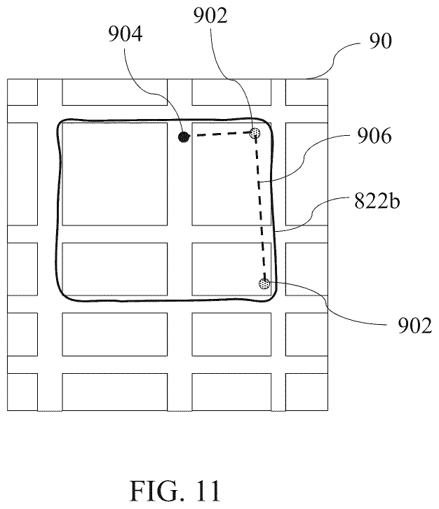

As shown in FIG. 11, based on the plurality of another geolocation information of the transfer items in the another list to be inspected, the electronic device 30b displays a plurality of another target locations 902 and another current location 904 of the electronic device 30b on another electronic map 90 on the screen 302 of the electronic device 30b, wherein the current location 904 is generated based on the geolocation information received by the electronic device 30b. The electronic device 30b generates another route 906 on the electronic map 90 from the current location 904 to the plurality of target locations 902.

In this way, inspection tasks for a plurality of the target assets within the same geographical area range could be assigned to a plurality of inspectors

Additionally, in the current embodiment, the data management system 1 further connects to an environmental information system 70 via the Internet 20, and the environmental information system 70 could be, for example, a public weather website. The environmental information system 70 is configured to provide at least one environmental parameter exemplified by temperature, but it is not limited thereto; the environmental parameter could also be humidity, rainfall, wind speed, etc.

Taking the asset data P01, which is considered the target asset data, as an example, the data management system 1 queries a maximum value and a minimum value of the environmental parameter in a predetermined period (e.g., twenty-four hours) from the environmental information system based on the geolocation information of the asset data P01. When the server 10 of the data management system 1 determines any of the maximum value and the minimum value of the environmental parameter during the predetermined period falls outside a standard operating value range, the predetermined inspection cycle is decreased accordingly. For example, the standard operating value range is the numerical range that the asset 501 (target asset) corresponding to the asset data P01 could operate normally. Taking the temperature as an example, the standard operating temperature range is −20 °C to 80 °C. In the case that the minimum value of the temperature during the predetermined period is −25 °C, the value is outside the standard operating temperature range of −20 °C to 80 °C, representing that the target asset is exposed to a harsher environment, so that the server 10 would move the end date in field F6 of the asset data P01 forward by predetermined days, for example, 30 days in advance to decrease the predetermined inspection cycle accordingly.

Every predetermined period, the server 10 of the data management system 1 queries the at least one environmental parameter from the environmental information system 70 based on the geolocation information of the target asset data to determine whether to decrease the predetermined inspection cycle of the target asset data.

Additionally, in the current embodiment, the database 12 of the data management system 1 includes a plurality of location information of a plurality of service centers for maintenance. When the inspector finds that the target asset under inspection needs to be maintained or repaired, the inspector operates the electronic device 30a to read the RFID tag 40 on the target asset through the RFID reading module 304 to obtain the unique identification code of the RFID tag 40. Then, the inspector operates the electronic device 30a to transmit a maintenance query request to the data management system 1, the maintenance query request including the unique identification code. Based on the geolocation information of the target asset data corresponding to the unique identification code in the maintenance query request, along with the plurality of location information of the plurality of service centers, the server 10 of the data management system 1 finds the location information of one service center situated nearest to the geolocation information of the target asset data and transmits the location information of one corresponding service center to the electronic device 30a. In this way, the inspector could deliver the target asset to the nearest service center for maintenance.

It must be pointed out that the embodiment described above is only a preferred embodiment of the present invention. All equivalent structures which employ the concepts disclosed in this specification and the appended claims should fall within the scope of the present invention.

1. An asset management method, applied to a data management system, the data management system including a database that stores a plurality of asset data corresponding to a plurality of assets, each of the plurality of asset data including an identification code corresponding to one of the assets; the asset management method comprising steps of:
A. providing an electronic device, wherein the electronic device has a radio-frequency identification (RFID) reading module; the electronic device reads an RFID tag on a target asset through the RFID reading module to obtain a unique identification code of the RFID tag; the electronic device receives a geolocation information from a positioning system;
B. connecting the electronic device to the data management system, and transmitting, by the electronic device, the unique identification code, the geolocation information and an inspection data to the data management system;
C. based on the unique identification code received, searching, by the data management system, for one corresponding asset data in the database to form a target asset data, wherein the identification code of the target asset data matches the unique identification code; and
D. determining, by the data management system, whether the geolocation information is located within a geographical area range of the target asset data, wherein:
when the geolocation information is located within the geographical area range of the target asset data, the data management system records the geolocation information and the inspection data in the target asset data;
when the geolocation information is located outside the geographical area range of the target asset data, the data management system transmits an alert message to the electronic device;
wherein multiple of the plurality of asset data in the database respectively have a first geolocation information;
subsequent to step D, the asset management method further includes:
selecting, by the data management system, at least one of the plurality of asset data corresponding to at least one of the plurality of first geolocation information located within the geographical area range to form at least one another target asset data;
generating, by the data management system, a list to be inspected including at least one item that includes the first geolocation information of the at least one another target asset data;
transmitting, by the data management system, the list to be inspected to the electronic device;
based on the first geolocation information of the at least one item in the list to be inspected, displaying, by the electronic device, at least one target location on an electronic map on a screen of the electronic device, and generating a route on the electronic map from a current location to the at least one target location, wherein the current location corresponds to the geolocation information;
wherein the data management system selects multiple of the plurality of first geolocation information that are located within the geographical area range; the at least one another target asset data includes a plurality of another target asset data; the at least one item in the list to be inspected includes a plurality of items, each item including the first geolocation information of each of the plurality of another target asset data;
based on the plurality of first geolocation information of the items of the list to be inspected, the electronic device displays the plurality of target locations on the electronic map on the screen of the electronic device, and the route displayed connects the current location and the plurality of target locations;
wherein, subsequent to step D, the asset management method further includes:
selecting, by the electronic device, a part of the items in the list to be inspected as a plurality of transfer items, and transmitting the plurality of transfer items to the data management system;
based on the transfer items received, generating, by the data management system, another list to be inspected;
connecting another electronic device to the data management system, wherein the another electronic device receives a second geolocation information from the positioning system and transmits the second geolocation information to the data management system;
transmitting, by the data management system, the another list to be inspected to the another electronic device when the data management system determines that the second geolocation information of the another electronic device is located within the geographical area range; and thereafter transmitting, by the data management system, a delete command to the electronic device, the delete command being configured to specify deletion of the transfer items in the list to be inspected;
after the electronic device receives the delete command, deleting, by the electronic device, the transfer items in the list to be inspected;
based on the plurality of first geolocation information of the items remaining in the list to be inspected, displaying, by the electronic device, the corresponding target locations on the electronic map on the screen of the electronic device and generating a new route, the new route connecting the current location and the corresponding target locations;
wherein, based on the plurality of first geolocation information of the transfer items in the another list to be inspected, the another electronic device displays a plurality of another target locations and another current location of the another electronic device on another electronic map on a screen of the another electronic device, and the another electronic device generates another route on the another electronic map from the another current location to the plurality of target locations;
wherein, subsequent to step D, the asset management method further includes:
connecting the data management system to an environmental information system, wherein the data management system queries the environmental information system for a maximum value and a minimum value of at least one environmental parameter in a predetermined period based on the geolocation information of the target asset data; the target asset data in the database includes a predetermined inspection cycle based on a standard operating value range of the at least one environmental parameter for the target asset;
repeating, by the data management system, the queries of the maximum value and the minimum value of at least one environmental parameter for every predetermined period;
automatically changing, by the data management system, the predetermined inspection cycle of the target asset data in the database to a shorter period in response to the maximum value or the minimum value of the at least one environmental parameter during the predetermined period falling outside the standard operating value range;
generating, by the data management system, an updated inspection cycle of the target asset data in the database; and performing inspection of the target asset based on the updated inspection cycle.

2. The asset management method as claimed in claim 1, comprising a setting step for setting the geographical area range of the target asset data, the setting step including:
reading, by the electronic device, the RFID tag on the target asset through the RFID reading module to obtain the unique identification code of the RFID tag; receiving, by the electronic device, a third geolocation information from the positioning system;
connecting the electronic device to the data management system, and transmitting, by the electronic device, the unique identification code and the third geolocation information to the data management system;
based on the unique identification code received, searching, by the data management system, for the corresponding target asset data in the database;
based on the third geolocation information received, creating, by the data management system, the geographical area range, and recording the geographical area range in the target asset data.

3. The asset management method as claimed in claim 2, wherein, in the setting step, the step that the data management system creates the geographical area range includes:
based on the third geolocation information received, generating, by the data management system, a map range selection page, wherein the map range selection page has an electronic map corresponding to the third geolocation information;
transmitting, by the data management system, the map range selection page to the electronic device for a user of the electronic device to select a predetermined range on the electronic map of the map range selection page;
transmitting, by the electronic device, the predetermined range to the data management system; and
based on the predetermined range, creating, by the data management system, the geographical area range.

4. The asset management method as claimed in claim 1, further comprising a change step when the geolocation information is outside the geographical area range of the target asset data, the change step including:
transmitting, by the data management system, an inquiry message to the electronic device, wherein the inquiry message is for asking a user of the electronic device whether to change the geographical area range;
transmitting, by the electronic device, a change request to the data management system;
based on the change request, recording, by the data management system, the geolocation information and the inspection data in the target asset data;
based on the geolocation information received, creating, by the data management system, a new geographical area range to update the geographical area range in the target asset data.

5. The asset management method as claimed in claim 4, wherein, in the change step, the step that the data management system creates the new geographical area range includes:
based on the geolocation information received, generating, by the data management system, a map range selection page, wherein the map range selection page has an electronic map corresponding to the geolocation information;
transmitting, by the data management system, the map range selection page to the electronic device for the user of the electronic device to select a predetermined range on the electronic map of the map range selection page;
transmitting, by the electronic device, the predetermined range to the data management system; and
based on the predetermined range, creating, by the data management system, the new geographical area range.

6.-9. (canceled)

10. The asset management method as claimed in claim 1, wherein the database of the data management system includes a plurality of location information of a plurality of service centers; subsequent to step D, the asset management method further includes:
reading, by the electronic device, the RFID tag on the target asset through the RFID reading module to obtain the unique identification code of the RFID tag, and transmitting, by the electronic device, a maintenance query request to the data management system, the maintenance query request including the unique identification code;
based on the geolocation information of the target asset data corresponding to the unique identification code in the maintenance query request, along with the plurality of location information of the plurality of service centers, finding, by the data management system, the location information of one service center situated nearest to the geolocation information of the target asset data and transmitting the location information of one corresponding service center to the electronic device.

11. The asset management method as claimed in claim 1, wherein step B includes that, when the electronic device is unable to connect to the data management system, the electronic device temporarily stores the unique identification code, the geolocation information and the inspection data in a storage medium of the electronic device.
